(19) United States
(12) Patent Application Publication
(10) Pub. No.: US 2013/0178100 A1
(43) Pub. Date: Jul. 11, 2013

(54) CONNECTOR AND ELECTRONIC DEVICE

(71) Applicants: Takayuki Nagata, Yao-shi (JP); Hideto Kobayashi, Isesaki-shi (JP)

(72) Inventors: Takayuki Nagata, Yao-shi (JP); Hideto Kobayashi, Isesaki-shi (JP)

(73) Assignee: HOSIDEN CORPORATION, Osaka (JP)

(21) Appl. No.: 13/819,381

(22) PCT Filed: Sep. 27, 2011
(86) PCT No.: PCT/JP2011/072038

§ 371 Date: Feb. 27, 2013

(30) Foreign Application Priority Data
Sep. 28, 2010 (JP) 2010-217669

(51) Int. Cl. H01R 13/648

(52) U.S. Cl. CPC H01R 13/648
USPC 439/607.35; 439/607.58

(57) ABSTRACT

A connector is provided in which a connector member is secured to a case and a shielding effect can be maintained even if a mating plug-type connector to be engaged therewith has a flat insulating plate with connecting portions on both of its faces, forming mutually parallel arrays of pluralities of upper terminals and lower terminals, which are strips of conductive segments. The connector member and the case are included. The connector member includes an inner shield cover that includes engaging portions having press-fractured faces, formed in its rear end. The case has resin springs which are disposed inside the tube-shaped portion of the case and extend toward the back and fixing stops which are disposed at free ends of the resin springs and increase in thickness inward from back to front.

### TECHNICAL FIELD

The present invention relates to a connector for making an electric connection and to an electronic device equipped with the connector.

### BACKGROUND ART

The connector disclosed in Patent Literature 1 is a known conventional technology. FIG. 1 is an exploded perspective view of the connector disclosed in Patent Literature 1. As shown in FIG. 1, a connector 40 includes a main housing 1, a connector housing 2, an inner shield case 3, and an outer shield case 5. The inner shield case 3 is inserted into the connector housing 2, which is made of an insulator. The connector housing 2 is then inserted into the main housing 1. Projections 19a and 19b formed on the connector housing 2 fit into respective grooves 10a and 10b in the main housing 1, thereby securing the connector housing 2 to the main housing 1. The outer shield case 5 is mounted to cover the main housing 1. With this configuration, the connector 40 achieves a double shield structure.

Patent literature 1: Japanese Patent Application Laid Open No. H8-106961

### DISCLOSURE OF THE INVENTION

### Problems to be Solved by the Invention

According to Patent Literature 1, a plate-type plug contact portion 4 is formed in the connector housing 2. Connecting portions 4a are formed on both faces of the plug contact portion 4. The connecting portions 4a on both faces have mutually parallel arrays of pluralities of upper terminals 12 and lower terminals 13, which are strips of conductive segments.

If the mating plug-type connector to be engaged with has a flat insulating plate with connecting portions on both of its faces, forming mutually parallel arrays of pluralities of upper terminals and lower terminals, which are strips of conductive segments, the plug contact portion 4 cannot be configured as described above. In order to make a connection with the plug-type connector of that type, the upper terminals 12 and lower terminals 13 are disposed on the inner upper wall and lower wall of the connector housing 2. The inner shield case 3 is disposed to cover the outer walls of the connector housing 2 so that it does not come into contact with the upper terminals 12 and lower terminals 13. In that configuration, however, the projections 19a and 19b are covered by the inner shield case 3, and the projections 19a and 19b cannot fit into the respective grooves 10a and 10b in the main housing 1. Thus, the connector housing 2 cannot be secured to the main housing 1. If large tabs are provided in the inner shield case 3 and fit into the grooves 10a and 10b instead of the projections 19a and 19b, the tabs could lower the shielding effect. Also, if the inner shield case 3 has large openings to expose the projections 19a and 19b of the connector housing 2, the openings could lower the shielding effect.

An object of the present invention is w provide a connector in which a connector member is secured to a case and a shielding effect can be maintained even if the mating plug-type connector to be engaged with has a flat insulating plate with connecting portions on both of its faces, forming mutually parallel arrays of pluralities of upper terminals and lower terminals, which are strips of conductive segments.

### Means to Solve the Problems

To solve the problems described above, a connector according to a first embodiment of the present invention includes a connector member and a case. The connector member includes a body, a plurality of contacts, and an inner shield cover. The body is made of an insulator and has an insertion opening into which the mating plug-type connector can be inserted, in its fore part, and an insertion space is formed to extend from the insertion opening toward the back. The contacts are arranged on inner walls of the insertion space of the body. Each contact includes a contact portion which comes into contact with a contact of the mating plug-type connector, a first terminal portion which becomes a terminal to a printed circuit board when the connector is mounted on the board, and a trunk portion which connects the contact portion and the first terminal portion. The inner shield cover includes a cover portion which covers the outer walls of the body, second terminal portions which become terminals to the board when the connector is mounted on the board, and engaging portions having press-fractured faces, formed in the rear end. The case is made of a tube-shaped insulator; portions of its inner walls are formed to cover the outer walls of the connector member; resin springs are disposed inside the tube-shaped insulator and extend toward the back; and fixing stops are disposed at free ends of the resin springs, and their thickness increases inward from back to front. When the connector member is inserted into the case from the back of the case, the resin springs are opened out elastically; when the connector member is inserted until the fixing stops reach the engaging portions, the resin springs restore their original states, and the fixing stops engage with the engaging portions of the inner shield cover.

### EFFECTS OF THE INVENTION

In the connector according to the present invention, since the fixing stops of the case engage with the engaging portions of the inner shield cover, the connector member is tightly secured to the case and a high shielding effect is provided, without providing a large opening or a large tab in the inner shield cover.

### BRIEF DESCRIPTION OF THE DRAWINGS

FIG. 1 is an exploded perspective view of a connector 40 in Patent Literature 1;

FIG. 2 is an exploded perspective view showing an example configuration of a connector 100;

FIG. 3 is an exploded perspective view showing an example configuration of a connector member 130;

FIG. 4A is a front view of a body 140;

FIG. 4B is a cross-sectional view along a line X-X′ in FIG. 4A;

FIG. 4C is a cross-sectional view along a line Y-Y′ in FIG. 4A;

FIG. 5 is a perspective view of a lower contact 152;

FIG. 6A is a right side view showing an upper contact 151 and the lower contact 152 guided by a spacer 170;

FIG. 6B is a cross-sectional view along a line W-W′ in FIG. 6A;

FIG. 7 is a perspective view of an inner shield cover 160;

FIG. 8 is a diagram illustrating how the connector 100 is disposed on a printed circuit board 210 of an electronic device 200;

FIG. 9 is a front view of the connector 100;

FIG. 10A is a right side view of the connector 100;

FIG. 10B is a cross-sectional view along a line U-U′ in FIG. 9;

FIG. 11A is a rear view of the connector 100 without an outer shield case 110;

FIG. 11B is a cross-sectional view along a line T-T′ in FIG. 11A;

FIG. 12 is an enlarged view of an area S in FIG. 11B; and

FIG. 13 is a perspective view showing the right side, back, and bottom of the connector 100 without the outer shield case 110.

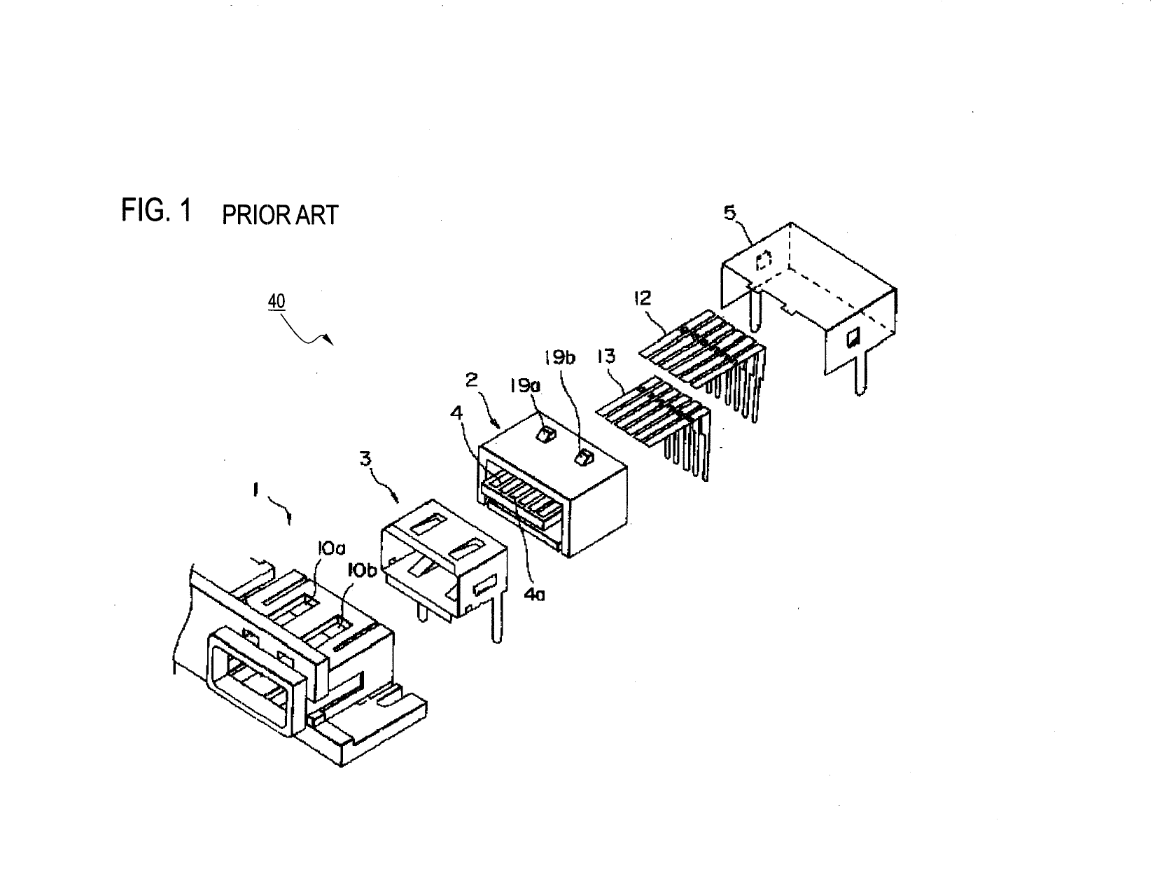

### BEST MODES FOR CARRYING OUT THE INVENTION

Now, an embodiment of the present invention will be described in detail.

### First Embodiment

[Connector 100]

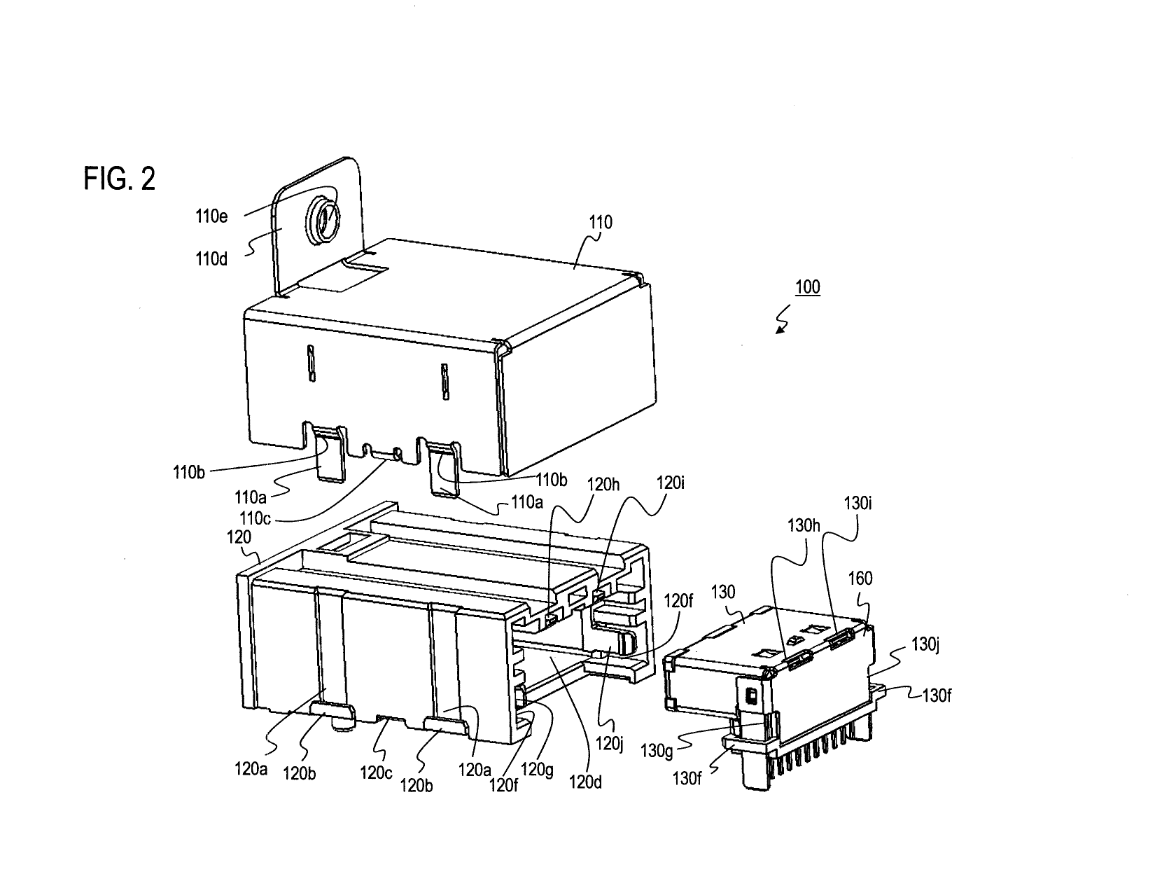

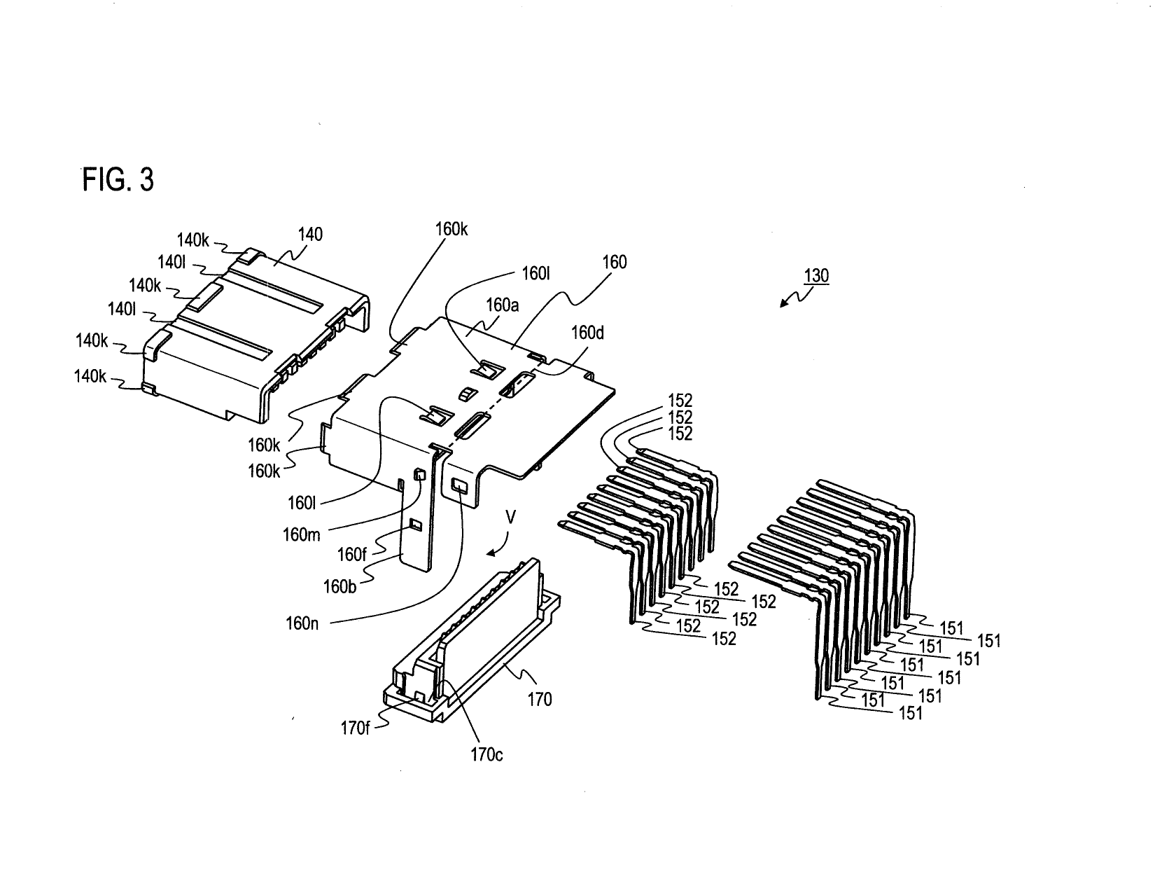

FIG. 2 shows a connector 100 according to a first embodiment. As shown in FIG. 2, the connector 100 includes an outer shield case 110, a case 120, and a connector member 130. As shown in FIG. 3, the connector member 130 includes a body 140, a plurality of contacts 151 and 152, an inner shield cover 160, and a spacer 170.

As shown in FIG. 2, resin springs 120g, 120h, 120i, and 120j are formed in the case 120. In the inner shield cover 160 of the connector member 130, engaging portions 130g, 130h, 130i, and 130j having press-fractured faces are formed. At the free ends of the resin springs 120g, 120h, 120i, and 120j of the case 120, fixing stops whose thickness increase inward from back to front are integrally formed. Therefore, when the connector member 130 is inserted into the case 120 from the back of the case 120, the resin springs 120g, 120h, 120i, and 120j are elastically opened out. They restore their original state after the connector member 130 reaches a given position. Then, the fixing stops engage with the engaging portions 130g, 130h, 130i, and 130j of the inner shield cover 160. Each part of the connector 100 will be described below in detail. In this embodiment, the front of the connector 100 is the face from which the mating plug-type connector to be engaged with is inserted; the bottom is the face at which the connector 100 is mounted on a printed circuit board; the front part and the lower part are respectively the fore part and the bottom part seen from the center of the connector 100.

[Body 140]

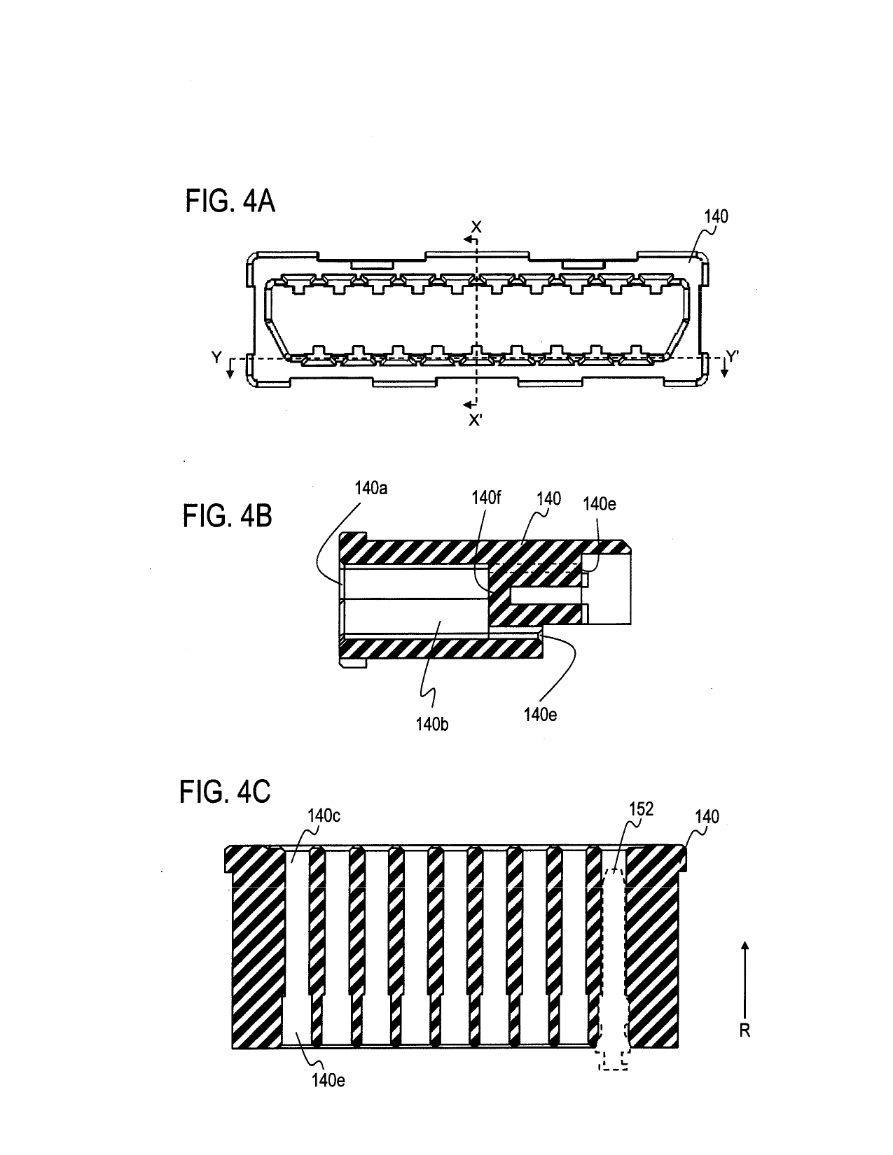

As shown in FIGS. 4A to 4C, the body 140 is made of an insulator and has an approximately rectangular box shape. In the body 140, an insertion opening 140a, an insertion space 140b, and a plurality of holes 140e are formed (see FIG. 4B). The insertion opening 140a is formed in the front part of the body 140 so that the mating plug-type connector to be engaged with can be inserted. The insertion space 140b is formed to extend from the insertion opening 140a toward a rear wall 140f. the plurality of holes 140e are formed in the rear wall 140f to allow the plurality of contacts to individually pass through. In FIG. 4B, the holes 140e for upper contacts 151, which will be described later, are indicated by broken lines.

The contacts, which will be described later, are disposed on the upper wall and the lower wall of the inner surfaces of the insertion space 140b of the body 140. For example, as shown in FIG. 4C, a plurality of contact grooves 140c individually corresponding to a plurality of lower contacts 152, which will be described later, are formed in the lower wall of the inner surfaces of the body 140. The contact grooves 140c are provided at regular intervals, extend in parallel from the insertion opening 140a to the rear wall 140f, and are connected to the holes 140e.

[Contacts]

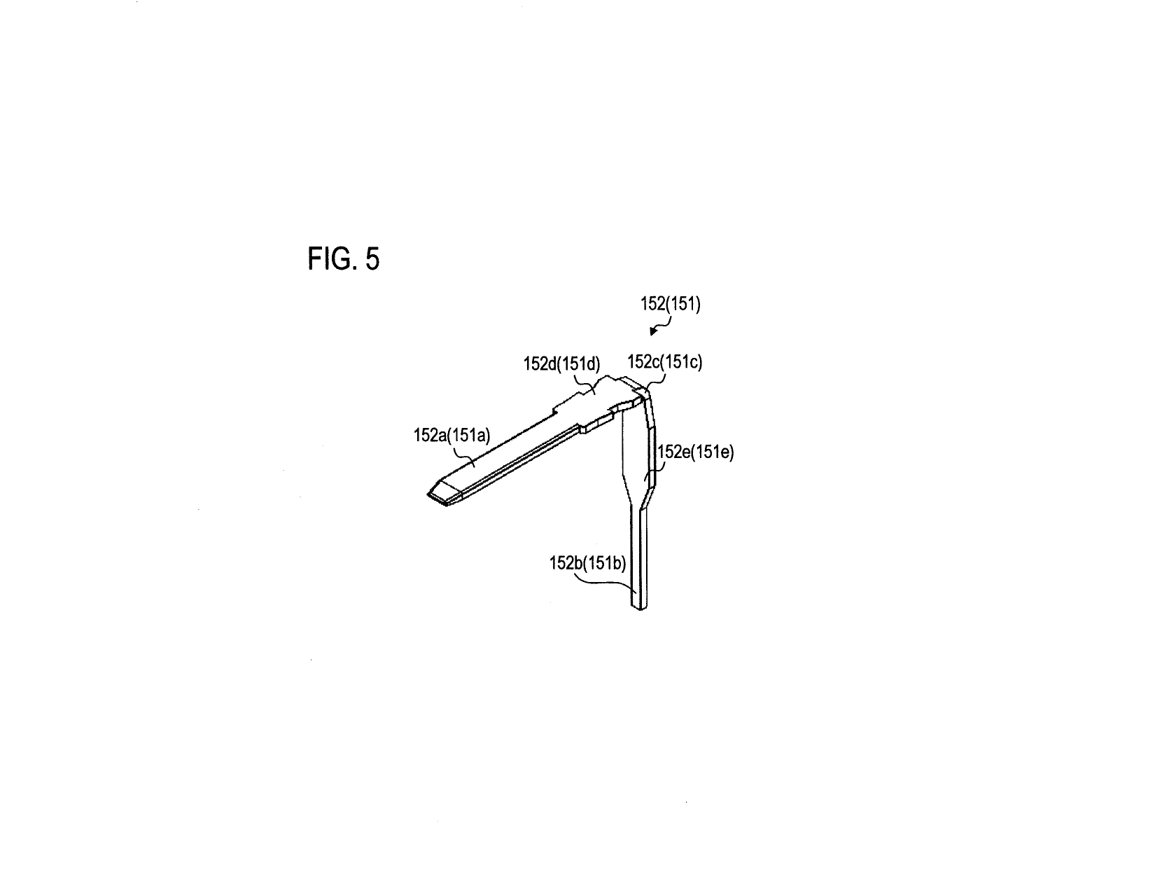

The plurality of contacts include one or more upper contacts 151 disposed on the upper wall of the inner surfaces of the insertion space in the body 140 and one or more lower contacts 152 disposed on the lower wall of the inner surfaces of the insertion space in the body 140 (see FIG. 3). The upper contacts 151 and the lower contacts 152 are made of a plate-type conductor. These contacts have similar structures, as shown in FIG. 5, and differ in the lengths of individual portions. The lower contact 152 includes a contact portion 152a, a first terminal portion 152b, and a trunk portion 152c. The contact portion 152a comes in contact with a contact of the mating plug-type connector. The first terminal portion 152b becomes a terminal to the board when mounted on the board. The trunk portion 152c connects the contact portion 152a and the first terminal portion 152b. The trunk portion 152c also includes a press-fit portion 152d connected to the contact pot 152a and a guide portion 152e connected to the first terminal portion 152b. The upper contact 151 also includes the corresponding portions 151a, 151b, 151c, 151d, and 151e, as indicated in parentheses in FIG. 5.

The contact portions 151a and 152a of the plurality of contacts 151 and 152 are individually disposed in the contact grooves 140c formed in the upper wall and lower wall of the inner surfaces of the insertion space 140b of the body 140.

The contact portion 152a of the lower contact 152 is press-fitted from the back of the body 140 toward the front (direction indicated by an arrow R in FIG. 4C), through the hole 140e (see FIG. 4B) (see FIG. 4C, where the rightmost lower contact 152 is indicated by a broken line for the sake of explanation). The press-fit portion 152d is formed to increase in width from front to back (see FIG. 5). After the press-fit portion 152d is press-fitted into the hole 140e and the lower contact 152 is inserted into the body 140, this shape prevents the lower contact 152 from falling out toward the back. The contact portion 152a is disposed in the contact groove 140c. The upper contacts 151 are disposed in the upper wall of the inner surfaces of the body 140 in the same manner.

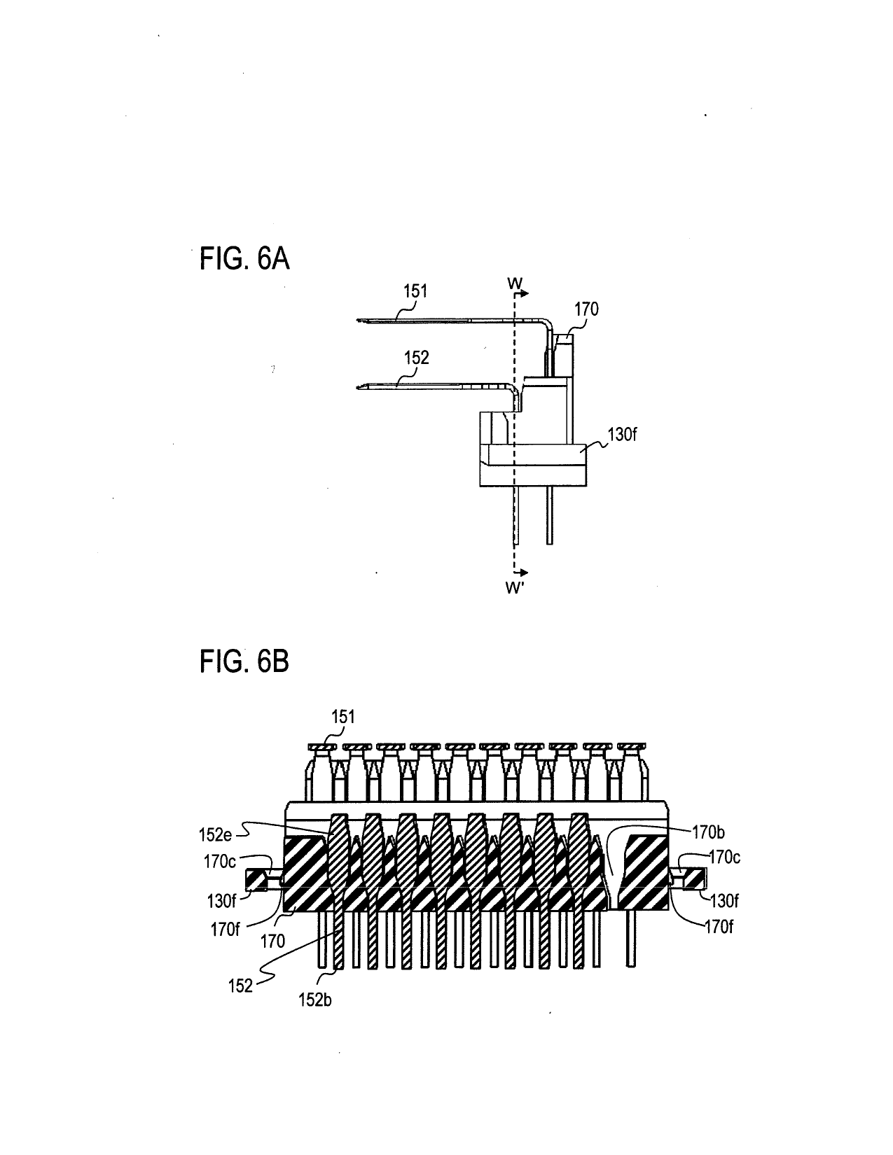

The trunk portion 152c is bent toward the mounting face (in the direction indicated by an arrow V in FIG. 3) at the back of the body 140. The first terminal portions 152b of the lower contacts 152 arranged as shown in FIGS. 6A and 6B are guided to given positions by the spacer 170. The guide portion 152e of the lower contact 152 has a portion reduced in width from top to bottom (FIG. 5). The spacer 170 has flat plate-shaped holes 170b (see FIG. 6B, in which the rightmost lower contact 152 is hidden for the sake of explanation). The hole 170b is formed to reduce in width from top to bottom and to come into contact with the first terminal portion 152b at its end. When the first terminal portion 152b of the lower contact 152 is inserted into the hole 170b from above the spacer, the first terminal portion 152b is guided to the position where the guide portion 152e engages with the hole 170b (see FIG. 6B). The upper contacts 151 are disposed in the same manner.

[Inner Shield Cover 160]

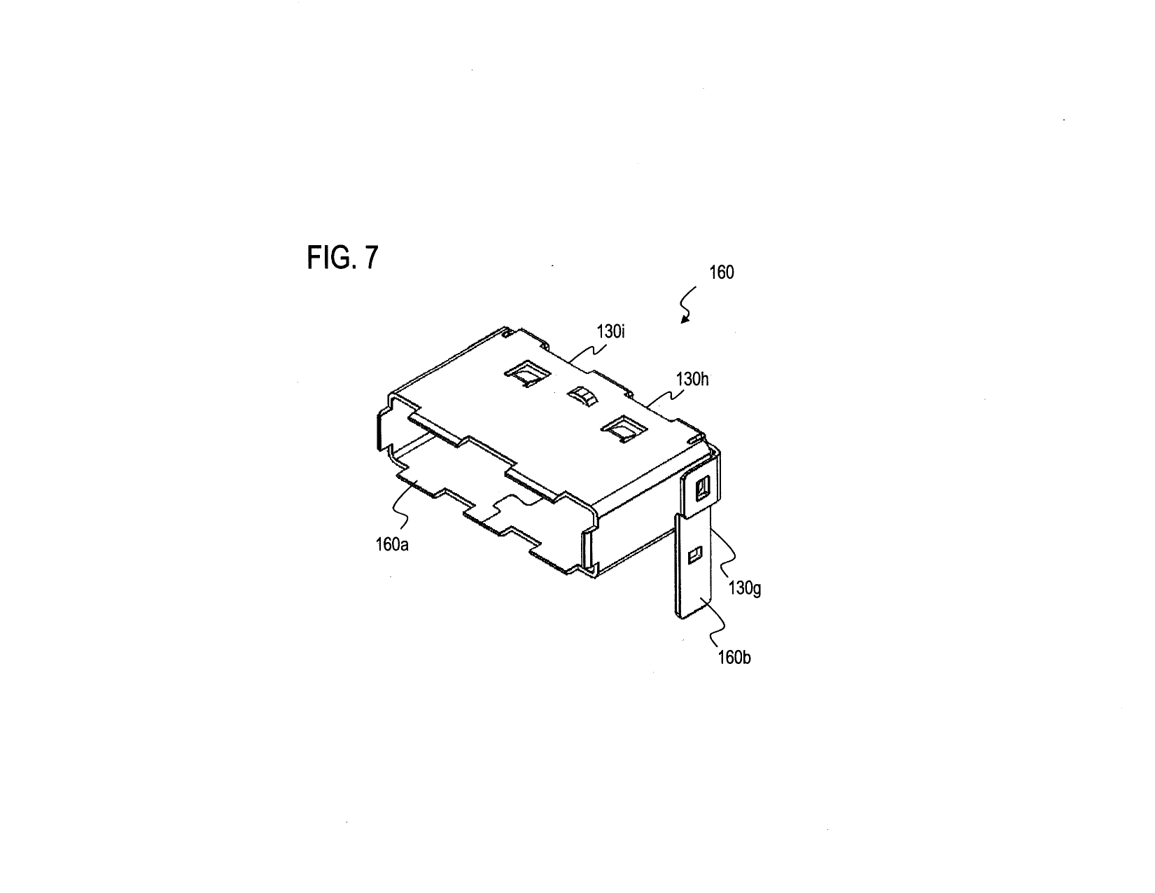

As shown in FIGS. 2 and 7, the inner shield cover 160 includes a cover portion 160a, second terminal portions 160b, and engaging portions 130g, 130h, 130i, and 130j. The cover portion 160a covers the outer faces of the body 140. The two second terminal portions 160b become terminals to the board when mounted on the board. The engaging portions 130g, 130h, 130i, and 130j are formed in the rear end. The rear end includes press-fractured faces.

The inner shield cover 160 is bent at the rear end of the body 140 perpendicularly to the direction in which the mating plug-type connector is inserted and toward the mounting face. The inner shield cover 160 is bent at a 90-degree angle along a broken-line portion 160d in the direction indicated by the arrow V.

The inner shield cover 160 is formed by pressing a conductor such as a metal plate. Elongated holes which will serve as the engaging portions 130h and 130i; the engaging portions 130g and 130j; 160l, 160m, 160n, and 160f; and the like are also formed. The metal plate to be used as the material is placed on the metal die, and a punch is pressed against it to remove the inner shield cover 160 from the metal plate. The portions where it is removed from the metal plate have fracture faces having sharp edges. The removed inner shield cover 160 is bent at given positions to form a rectangular tube having two side faces, a top face, and a bottom face, as shown in FIG. 3. The body 140, the plurality of contacts 151 and 152, and the spacer 170 are inserted into the inner shield cover 160, and then, the back of the inner shield cover 160 is bent along the back end of the top face of the body 140 perpendicularly to the direction in which the mating plug-type connector is inserted and toward the mounting face (in the direction indicated by the arrow V in FIG. 3), to form the shape shown in FIG. 7.

[Spacer 170]

As shown in FIGS. 6A and 6B, the spacer 170 is made of an insulator and has a plurality of holes 170b corresponding to the plurality of first terminal portions 151b and 152b and two holes 170c corresponding to the two second terminal portions 160b. The holes 170b and 170c pass through the spacer 170 vertically. Engaging portions 130f are formed by making through holes 170c in plate portions that extend sideways. When the first terminal portions 151b and 152b and the second terminal portions 160b are inserted into the spacer 170 from top to bottom, the holes 170b and 170c guide the first terminal portions 151b and 152b and the second terminal portions 160b to given positions, respectively. In this way, the spacer 170 keeps such spacings that the upper contacts 151, the lower contacts 152, and the inner shield cover 160 are kept separated.

[Assembly of the Connector Member 130]

The connector member 130 includes the body 140, the plurality of contacts 151 and 152, the inner shield cover 160, and the spacer 170, as described earlier (see FIG. 3). First, the body 140 is inserted into the rectangular tube part formed by the cover portion 160a of the inner shield cover 160. Then, the contacts 151 and 152 are press-fitted into the body 140 from the back thereof. The trunk portions 151c and 152c of the contacts 151 and 152 are bent in the direction indicated by the arrow V in FIG. 3 (the direction perpendicular to the direction of insertion and toward the mounting face). The first terminal portions 151b and 152b of the contacts 151 and 152 and the second terminal portions 160b of the inner shield cover 160 are inserted into the spacer 170 from above thereof to dispose the first terminal portions 151b and 152b and the second terminal portions 160b in given positions. The inner shield cover 160 is then bent in the direction indicated by the arrow V in FIG. 3 at the rear end of the body 130. In this way, the connector member 130 is assembled (see FIG. 2).

The body 140 has a plurality of guard portions 140k protruding outward at its front end, as shown in FIG. 3. The inner shield cover 160 has a plurality of convex portions 160k protruding forward at its front end, each convex portion corresponding to each concave portion formed between the adjacent guard portions 140k. In the top face of the body 140, two grooves 140l are formed from the front end toward the back. The grooves 140l do not reach the back end of the body 140 and have their ends in the top face of the body 140. In the top face of the inner shield cover 160, two tab portions 160l are formed and pulled down. When the body 140 is inserted into the rectangular tube part formed by the cover portion 160a of the inner shield cover 160, the guard portions 140k mesh with the convex portions 160k. This structure secures the body 140 and the inner shield cover 160 vertically and horizontally. When the body 140 is inserted, the tab portions 160l are elastically opened out (upward). When the tab portions 160l reach the grooves 140l in the top face of the body 140, the tab portions 160l restore their original states. The guard portions 140k provided in the front end of the body 140 engage with the front end of the inner shield cover 160, and the ends of the grooves 140l provided in the top face of the body 140 engage with the tab portions 160l of the inner shield cover, and consequently the body 140 and the inner shield cover 160 are secured in the longitudinal direction.

Fitting holes 160f are formed in the upper parts of the second terminal portions 160b of the inner shield cover 160, as shown in FIG. 3. In the inner faces of the holes 170c of the spacer 170, projections 170f increasing in thickness from top to bottom are formed (see FIG. 6B). When the second terminal portions 160b of the inner shield cover 160 are inserted into the holes 170c from above the spacer 170, the projections 170f cause the second terminal portions 160b to elastically open outward. When the projections 170f reach the fitting holes 160f, the second terminal portions 160b restore their original states. This structure prevents the spacer 170 from falling down. The top of the spacer 170 comes into contact with the body 140 and the inner shield cover 160, and the inner shield cover 160 and the spacer 170 are secured vertically.

Tabs 160m are formed at the side faces of the cover portion 160a of the inner shield cover 160, as shown in FIG. 3, and holes 160n are formed at the back side faces. When the rear portion of the inner shield cover 160 is bent in the direction indicated by the arrow V in FIG. 3, the tab 160m fit in the holes 160n. This structure holds the inner shield cover 160 in the shape shown in FIG. 7.

[Case 120]

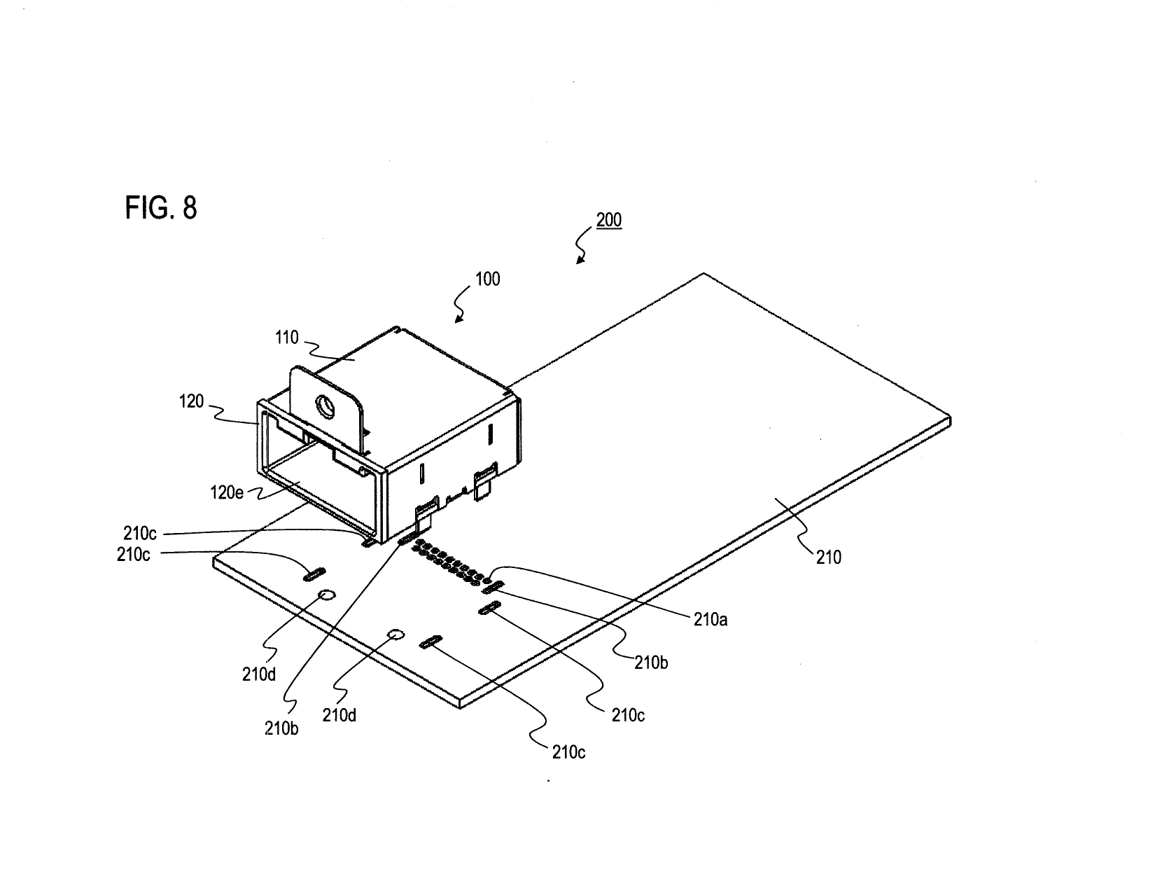

The case 120 is an insulator and has a rectangular tube shape. The case 120 has openings 120e and 120d which are connected. The opening 120e is formed in the fore part of the case 120 to become an insertion opening for the mating plug-type connector (see FIG. 8). The opening 120d is formed in the back part of the case 120 to become an insertion opening for the connector member 130 (see FIG. 2).

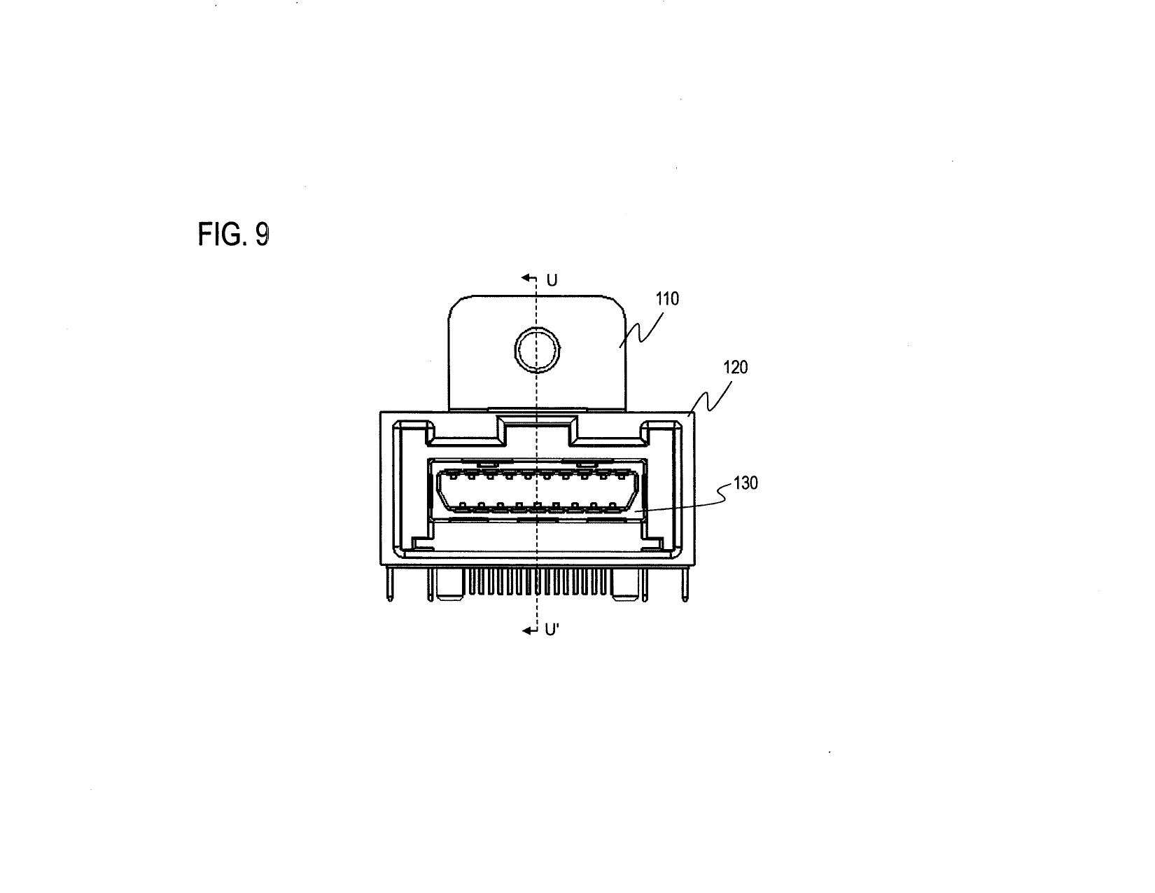

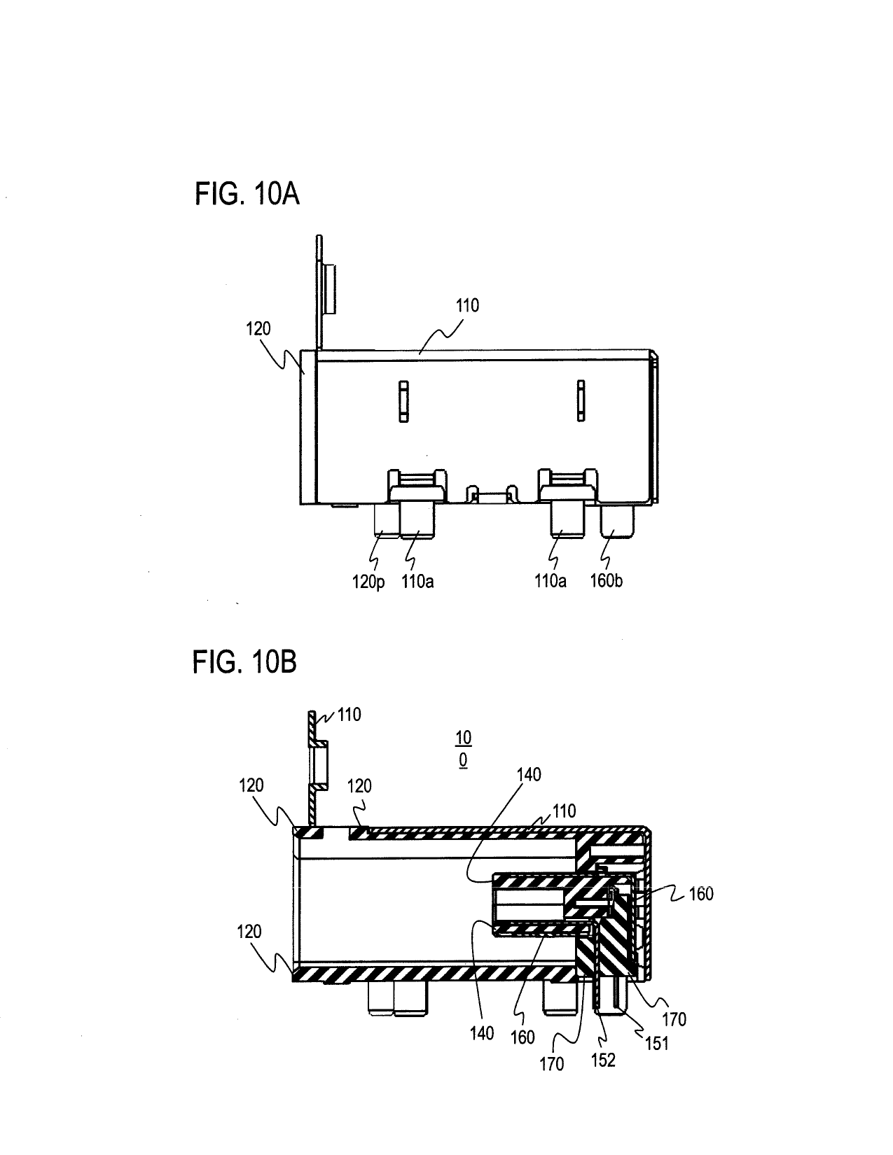

The case 120 is formed so that portions of its inner walls cover the outer walls of the connector member 130, as shown in FIGS. 9, 10A, and 10B.

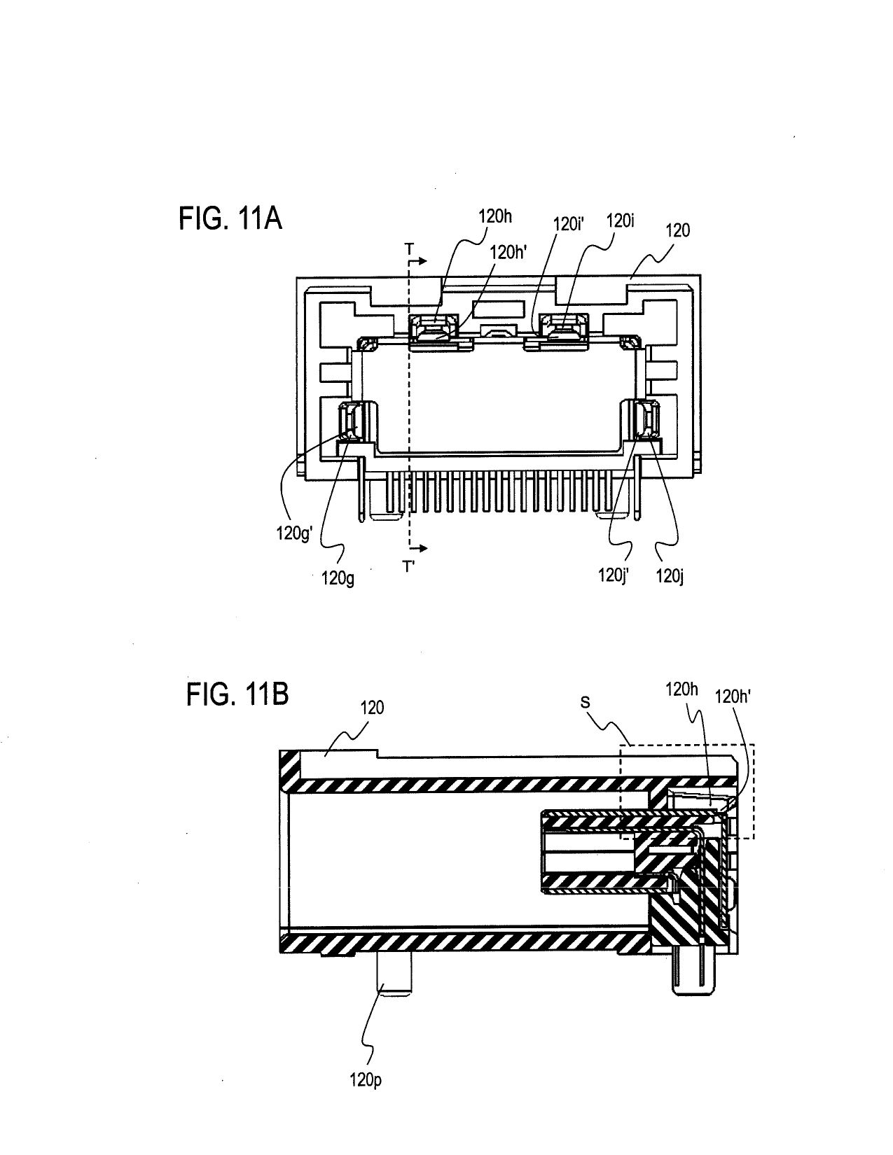

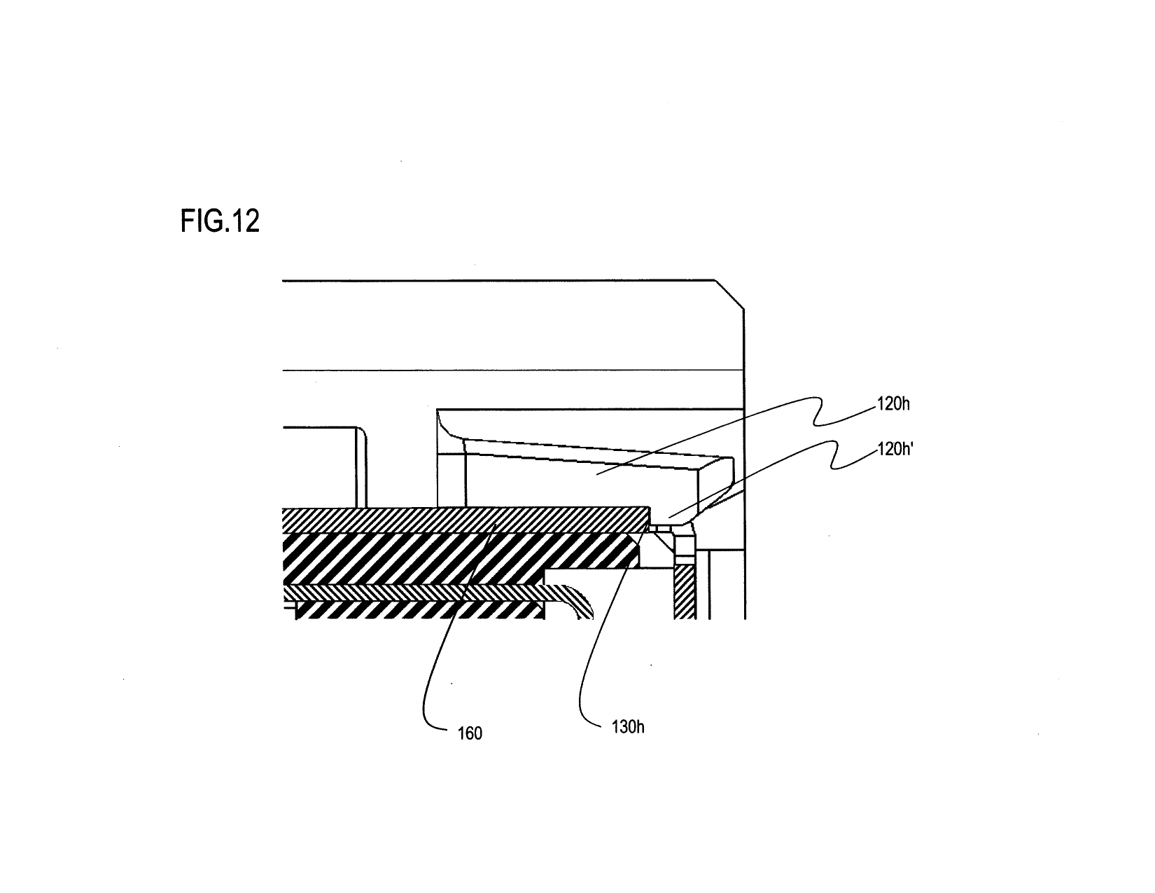

The case 120 has resin springs 120g, 120h, 120i, and 120j integrally formed with fixing stops 120g′, 120h, 120i′, and 120j′, respectively, as shown in FIGS. 11A, 11B, and 12. The resin springs 120g, 120h, 120i, and 120j are disposed inside the case and extend backward. The fixing stops 120g′, 120h′, 120i′, and 120j′ are disposed at the free ends of the resin springs and increase in thickness inward from back to front. FIG. 12 shows the shapes of the resin spring 120h and the fixing stop 120h′. The resin springs 120g, 120i, and 120j have the same shape as the plastic spring 120h, and the fixing stops 120g′, 120i′, and 120j′ have the same shape as the fixing stop 120h′.

Slits 120f are formed below the resin springs 120g and 120j in the inner walls of the case 120 (see FIG. 2).

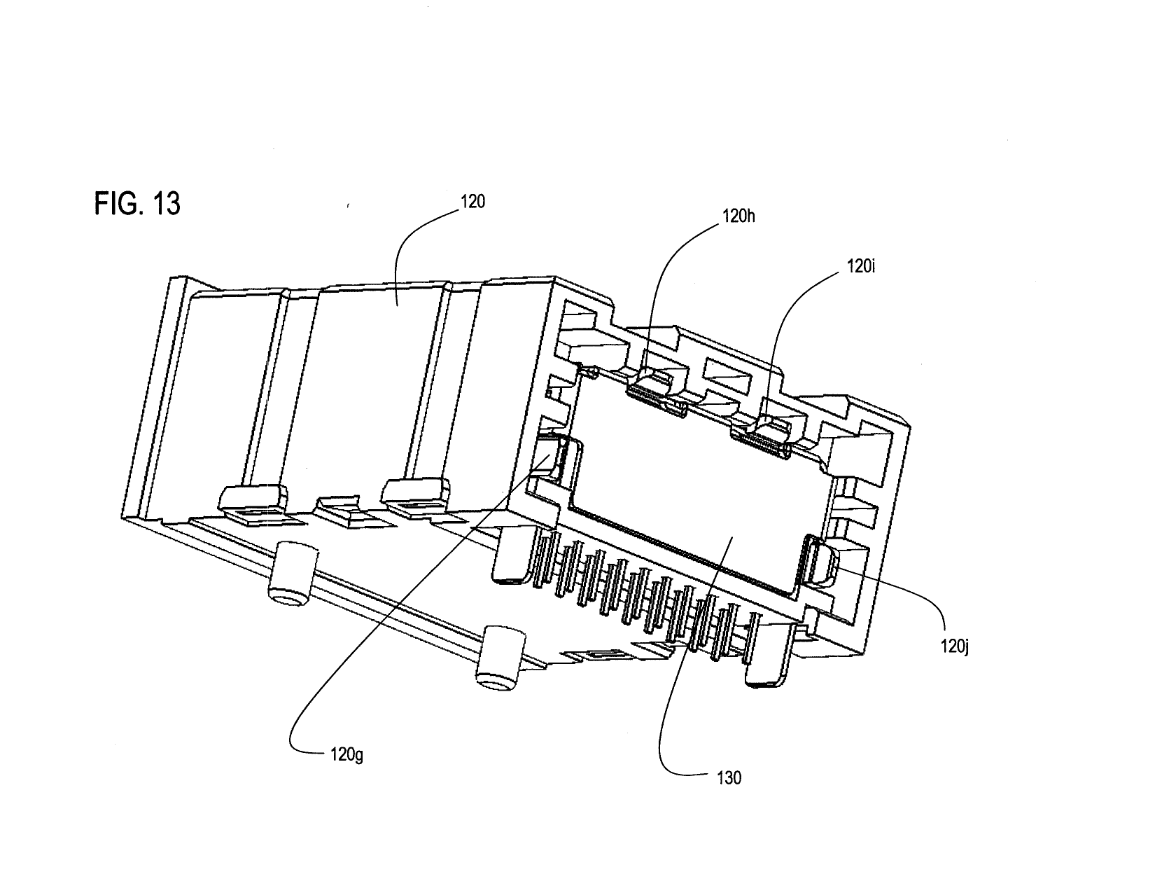

When the connector member 130 is inserted into the case 120 from the back thereof (see FIG. 2), the front edge of the connector member 130 engages with the fixing stops 120g′, 120i′, 120j′, and 120h′ of the case 120, and the resin springs 120g, 120h, 120i, and 120j of the case 120 are opened out elastically. After the connector member 130 reaches a given position, the resin springs 120g, 120h, 120i, and 120j restore their original states (see FIGS. 11A, 11B, 12, and 13). The given position is reached, for example, when the connector member 130 is inserted until the fixing stops 120g′, 120h′, 120i′, and 120j′ reach the respective engaging portions 130g, 130h, 130i, and 130j of the inner shield cover 160. The fixing stops 120g′, 120h′, 120i′, and 120j′ stop in an engaged state in the engaging portions 130g, 130h, 130i, and 130j of the inner shield cover 160 (see FIG. 12). The engaging portions 130f formed in the spacer 170 included in the connector member 130 are inserted into the slits 120f (see FIG. 2). The front edges of the engaging portions 130f come into contact with the ends of the slits 120f. With this structure, the connector member 130 is secured to the case 120 longitudinally, horizontally, and vertically. The connector member 130 is secured to the case 120 longitudinally by the back face of the case 120, the slits 120f, the fixing stops 120g′, 120h′, 120i′, and 120j′, the front face of the connector member 130, the engaging portions 130f, and the engaging portions 130g, 130h, 130i, and 130j. The connector member 130 is secured to the case 120 vertically and horizontally by the inner walls of the case 120 and the outer walls of the connector member 130.

Since the press-fractured faces are substantially flat, the engagement allowance of the fixing stops 120g′, 120h′, 120i′, and 120j′ can be reduced. For example, if the fixing stops 120g′, 120h′, 120i′, and 120j′ engage with bends in the rear end of the inner shield cover 160 instead of the press-fractured faces, a larger engagement allowance is required because of the radius of curvature of the bends, in comparison with when the fixing stops engage with the flat press-fractured faces. In addition, the bends are likely to vary in position or in angle. The variations will lead to unsteadiness in engagement of the fixing stops 120g′, 120h′, 120i′, and 120j′. In contrast, the press-fractured faces can be precisely formed, and therefore, such a problem does not occur. By reducing the engagement allowance of the fixing stops 120g′, 120h′, 120i′, and 120j′, the distance over which the fixing stops are guided toward the rear part of the connector member 130 can be reduced. Consequently, the overall length of the connector 100 can be reduced, and the size can be reduced.

[Outer Shield Case 110]

The outer shield case 110 is a conductor and has a rectangular box shape, as shown in FIGS. 2, 10A, and 10B. The outer shield case 110 covers the outer walls of the case 120, excluding the front and bottom faces of the case 120. A plurality of step portions 110b and a plurality of third terminal portions 110a are formed in both side faces of the outer shield case 110. The step portion 110b is bent inward and then bent downward in parallel with the side face. The third terminal portion 110a extends downward from the step portion 110b. The third terminal portions 110a slide downward in guide grooves 120a extending vertically in both side faces of the case 120, and the step portions 110b engage with supporting portions 120b. The outer shield case 110 is secured to the case 120 longitudinally by the third terminal portions 110a fitting in the guide grooves 120a. The outer shield case 110 is secured to the case 120 horizontally by the third terminal portions 110a engaging with the supporting portions 120b.

Engaging stops 110c of the outer shield case 110 are bent inward. When the engaging stops 110c engage with engaging portions 120c of the case 120, the assembly is completed. The outer shield case 110 is secured to the case 120 vertically.

This configuration provides a double shield structure and improves the shielding effect.

[Electronic device 200 Equipped With the Connector 100]

The connector 100 is mounted on a printed circuit board 210 of an electronic device 200 as shown in FIG. 8. The board 210 of the electronic device 200 has first through-holes 210a into which the first terminal portions 151b and 152b are inserted, second through-holes 210b into which the second terminal portions 160b are inserted, third through-holes 210c into which the third terminals 110a are inserted, and printed wiring. At least as many through-holes as corresponding terminal portions are provided.

The connector 100 is secured to the board 210 longitudinally, horizontally, and vertically when the first terminal portions 151b and 152b and the second terminal portions 160b are individually soldered onto the board 210. The second terminal portions 160b and third terminals 110a are grounded via the second through holes 210b and the third through holes 210c, respectively. The first contact portions 151b and 152b are connected to wiring via the first through-holes 210a.

Projecting portions 120p are formed in the front part of the bottom face of the case 120 (see FIG. 10A). Fourth through-holes 210d into which the projecting portions 120p are inserted are formed in the board 210 (see FIG. 8). The connector 100 can be secured to the board 210 longitudinally and horizontally by inserting the projecting portions 120p into the fourth through-holes 210d. With this structure, when the mating plug-type connector is attached or detached, the loads exerted on the terminal portions can be reduced.

The outer shield case 110 has a flange 110d extending upward in its front end, as shown in FIG. 2. The flange 110d may have a threaded hole 110e at its center. If the threaded hole 110e is provided, the connector 100 can be fastened to a housing (not shown) of the electronic device 200 by a screw. The outer shield case 100 is grounded with the housing through the flange 110d.

[Effects]

With the configuration described above, even if the mating plug-type connector includes a flat insulating plate with connecting portions on both of its faces, which connecting portions include mutually parallel arrays of pluralities of upper terminals and lower terminals, which are strips of conductive segments, the portions in contact with the mating plug-type connector can be covered by the inner shield cover 160. Therefore, the connector 100 can maintain a high shielding effect. The fixing stops of the case 120 engage with the engaging portions of the inner shield cover 160 having press-fractured faces, and the position of the contained connector member 130 is secured. Therefore, the need to provide a large tab or a large hole in the inner shield is eliminated, and the body 140 does not have to be exposed. The back end of the inner shield case 3 in Patent Literature 1 is open so that the upper terminals and lower terminals can pass through. Since the inner shield cover 160 of the connector 100 covers all of the contacts from the outside, the inner shield cover 160 does not require an open back end, and the shielding effect is improved.

[Other Modifications]

The resin springs and fixing stops of the case 120 need to be provided at least on either side wall of the inner faces of the case 120 and at least on either the upper wall or the lower wall of the inner faces, and engaging portions need to be provided at least in the corresponding positions of the connector member 130.

When the connector member 130 is assembled, the contacts may be press-fitted into the body 140 after the trunk portions 151c and 152c of the contacts are bent.

The embodiment of the present invention is provided merely for the purpose of illustration and description. It is not intended to be comprehensive, nor is it intended to confine the present invention strictly to the disclosed style. Therefore, modifications and variations can be allowed from the above-described teaching. The embodiment is a representation chosen to provide the best illustration of the principle of the present invention and to allow those skilled in the art to use the present invention in a variety of embodiments suited to carefully considered applications and to add a variety of modifications. All the modifications and variations are within the scope of the present invention determined by attached claims interpreted according to the range given fairly, legitimately, and impartially.

1. A connector comprising a connector member and a case, the connector member comprising:
a body being made of an insulator, having an insertion opening where a mating plug-type connector can be inserted, in a fore part of the body, and an insertion space extending from the insertion opening toward the back of the body;
a plurality of contacts being arranged on inner walls of the insertion space of the body, each comprising
a contact portion which comes into contact with a contact of the mating plug-type connector;
a first terminal portion which becomes a terminal to a printed circuit board when the connector is mounted on the board; and
a trunk portion which connects the contact portion and the first terminal portion; and
an inner shield cover comprising
a cover portion which covers the outer walls of the body;
second terminal portions which become terminals to the board when the connector is mounted on the board; and
engaging portions having press-fractured faces, formed in a rear end of the inner shield cover;
the case being made of a tube-shaped insulator and having portions of the inner walls thereof formed to cover the outer walls of the connector member, resin springs disposed inside the tube-shaped insulator and extending toward the back of the case, and fixing stops disposed at free ends of the resin springs and increasing in thickness inward from back to front;
when the connector member is inserted into the case from the back of the case, the resin springs being opened out elastically, and when the connector member is inserted until the fixing stops reach the engaging portions, the resin springs restoring the original states thereof and the fixing stops engaging with the engaging portions of the inner shield cover.

2. The connector according to claim 1, wherein the connector member further comprises a spacer which is made of an insulator and keeps a spacing such that the contacts do not come into contact with the inner shield cover; and
the contacts are press-fitted into the body, the trunk portions are bent in the rear part of the body toward the mounting face, the first terminal portions are guided to given positions by the spacer, and the inner shield cover is bent at the rear end of the body in a direction perpendicular to the insertion direction of the mating plug-type connector and toward the mounting face.

3. The connector according to claim 1, further comprising an outer shield case that covers the outer walls of the case.

4. (canceled)

5. The connector according to claim 2, further comprising an outer shield case that covers the outer walls of the case.

6. An electronic device comprising a connector, the connector being mounted on a printed circuit board and comprising a connector member and a case, the connector member comprising:
a body being made of an insulator, having an insertion opening where a mating plug-type connector can be inserted, in a fore part of the body, and an insertion space extending from the insertion opening toward the back of the body;
a plurality of contacts being arranged on inner walls of the insertion space of the body, each comprising
a contact portion which comes into contact with a contact of the mating plug-type connector;
a first terminal portion which becomes a terminal to a printed circuit board when the connector is mounted on the board; and
a trunk portion which connects the contact portion and the first terminal portion; and
an inner shield cover comprising
a cover portion which covers the outer walls of the body;
second terminal portions which become terminals to the board when the connector is mounted on the board; and
engaging portions having press-fractured faces, formed in a rear end of the inner shield cover;
the case being made of a tube-shaped insulator and having portions of the inner walls thereof formed to cover the outer walls of the connector member, resin springs disposed inside the tube-shaped insulator and extending toward the back of the case, and fixing stops disposed at free ends of the resin springs and increasing in thickness inward from back to front;
when the connector member is inserted into the case from the back of the case, the resin springs being opened out elastically, and when the connector member is inserted until the fixing stops reach the engaging portions, the resin springs restoring the original states thereof and the fixing stops engaging with the engaging portions of the inner shield cover.

7. The electronic device according to claim 6, wherein the connector member further comprises a spacer which is made of an insulator and keeps a spacing such that the contacts do not come into contact with the inner shield cover; and
the contacts are press-fitted into the body, the trunk portions are bent in the rear part of the body toward the mounting face, the first terminal portions are guided to given positions by the spacer, and the inner shield cover is bent at the rear end of the body in a direction perpendicular to the insertion direction of the mating plug-type connector and toward the mounting face.

8. The electronic device according to claim 6, further comprising an outer shield case that covers the outer walls of the case.

9. The electronic device according to claim 7, further comprising an outer shield case that covers the outer walls of the case.
